(19) United States
(12) Patent Application Publication
(10) Pub. No.: US 2024/0165560 A1
(43) Pub. Date: May 23, 2024

(54) PHOTOELECTROCATALYTIC REACTION DEVICE FOR HIGH-PRESSURE ENVIRONMENTS AND APPLICATION THEREOF

(71) Applicant: TIANJIN UNIVERSITY, Tianjin (CN)

(72) Inventors: Jinlong GONG, Tianjin (CN); Gong ZHANG, Tianjin (CN); Tuo WANG, Tianjin (CN); Yongtao WANG, Tianjin (CN); Hui GAO, Tianjin (CN); Peng ZHANG, Tianjin (CN)

(21) Appl. No.: 18/202,636

(22) Filed: May 26, 2023

(30) Foreign Application Priority Data
Nov. 18, 2022 (CN) 202211445008X

(51) Int. Cl. B01D 53/86; B01D 53/32; B01D 53/62

(52) U.S. Cl. CPC B01D 53/86; B01D 53/32; B01D 53/62

(57) ABSTRACT

The present disclosure belongs to the technical field of electrochemical reactions, and discloses a photoelectrocatalytic reaction device for high-pressure environments and application thereof. An anode reactor and a cathode reactor have the same structure, are arranged in a mutual mirroring manner, and each include a reaction cavity and a cover plate. The reaction cavities are provided with round sapphire optics windows and connecting channels, and an ion exchange membrane is arranged between the connecting channels. The cover plates are provided with gas inlet pipeline connectors, gas outlet pipeline connectors, safety valves and pressure meters. Terminals are hermetically installed on the cover plates, metal copper rods are embedded into the terminals along central axes of the terminals, and inserting holes used for being connected with electrodes in an inserted manner are formed in bottoms of the metal copper rods. The device is especially suitable for analyzing properties of electrocatalytic.

### CROSS-REFERENCE TO RELATED APPLICATION

This application claims priority from the Chinese patent application 202211445008X filed Nov. 18, 2022, the content of which is incorporated herein in the entirety by reference.

### TECHNICAL FIELD

The present disclosure belongs to the technical field of electrochemical reactions, and particularly relates to a photoelectrocatalytic reaction device and application thereof.

### BACKGROUND ART

In recent years, with the increase of human activities and the rapid consumption of fossil energy, concentrations of greenhouse gases in the atmosphere, which are mainly based on carbon dioxide, have been continuously increased. Thus, the control over the concentration of carbon dioxide gas in the atmosphere has become a current research hotspot. In nature, photosynthesis in green plants is ubiquitous. From an energy perspective, the green plants convert the carbon dioxide in the atmosphere into organic substances such as saccharides by utilizing solar energy, and meanwhile convert the solar energy into chemical energy stored in chemical bonds, which can enlighten the development of low-energy carbon dioxide conversion and utilization technologies. A technology that uses photovoltaic devices to convert the solar energy into electricity and use the electricity to drive the electrocatalytic reduction of carbon dioxide to obtain methanol, ethanol and other carbonaceous products is the most promising technology for utilizing the carbon dioxide at present. However, the solubility of the carbon dioxide in an aqueous solution is only 33 mM at ambient temperature and pressure, which limits the improvement of reaction activity and selectivity^{[1]}. By increasing the gas pressure and performing electrocatalytic reduction of the carbon dioxide at high pressure, not only can improve the solubility of the carbon dioxide in the aqueous solution^{[2]}, but also achieve the direct utilization of industrially generated high-pressure waste carbon dioxide gas^{[3]}. However, existing high-pressure reaction devices have the problems such as complex structures and difficult collection of products. For example, the research group of Professor Wang Haihui at the South China University of Technology achieved reaction pressure control by placing an unclosed glass H-type reactor into a closed pressure tank and adjusting gas pressure inside the pressure tank^{[4]}. Due to such design, gas phase oxidation and reduction products are mixed in the large pressure tank, the products diluted and the reduction products re-oxidized, resulting in a failure in accurate quantitative analysis on the gas phase reduction products. Since the reactor is located inside the sealed pressure tank, external power supply needs a complex feedthrough connector to achieve connectivity of circuits inside and outside the pressure tank, which makes the circuits redundant and leads to complex operation. The research group of Professor Dai Hongjie at Stanford University designed a high-pressure electrocatalytic reaction device that does not rely on a pressure tank^{[5]}. Such reactor is provided with two cavities that can be connected, and the catholyte and the anolyte is separated by an ion exchange membrane. However, headspaces of the two cavities are still unseparated, which makes it necessary to add extra deoxidizer into the reactor to avoid re-oxidation of cathode reduction products by the anode oxygen. Moreover, in order to ensure sealing, electrode clamps were directly welded to the reactor, which made it difficult to rapidly replace electrodes. In addition, the existing high-pressure reactors do not have the ability to receive light for photoelectrocatalytic reactions^{[6]}. In summary, the development of a high-pressure reaction device with good sealing and mass transfer properties, effective product collection, light illumination and fast switching of circuits and electrodes is an important methods to promote the development of a carbon dioxide reduction technology.

### REFERENCES

[1] D. M. Weekes, D. A. Salvatore, A. Reyes, A. Huang, C. P. Berlinguette, Acc. Chem. Res. 2018, 51, 910-918.
[2] M. Ramdin, A. R. T. Morrison, M. de Groen, R. van Haperen, R. de Kler, L. J. P. van den Broeke, J. P. M. Trusler, W. de Jong, T. J. H. Vlugt, Ind. Eng. Chem. Res. 2019, 58, 1834-1847.
[3] K. Deng, H. Feng, D. Liu, L. Chen, Y. Zhang, Q. Li, J. Mater. Chem. A 2021, 9, 3961-3967.
[4] H. Cheng, P. Cui, F. Wang, L. X. Ding, H. Wang, Angew. Chem. Int. Ed. 2019, 58, 15541-15547.
[5] J. Li, Y. Kuang, Y. Meng, X. Tian, W. H. Hung, X. Zhang, A. Li, M. Xu, W. Zhou, C. S. Ku, C. Y. Chiang, G. Zhu, J. Guo, X. Sun, H. Dai, J. Am. Chem. Soc. 2020, 142, 7276-7282.
[6] C. C. Li, T. Wang, B. Liu, M. X. Chen, A. Li, G. Zhang, M. Y. Du, H. Wang, S. F. Liu, J. L. Gong, Energy Environ. Sci. 2019, 12, 923-928.

### SUMMARY

The present disclosure aims at providing a photoelectrocatalytic reaction device for high-pressure environments and application thereof in order to overcome the defects in the prior art. The device can rapidly and conveniently apply light and external bias voltages, and has a good mass transfer property. Meanwhile, the device is excellent in gas tightness and small in size, products can be easily separated, which is especially suitable for analyzing properties of electrocatalytic and photoelectrocatalytic carbon dioxide reduction reactions by catalytic materials such as transition metals, non-metals and semiconductors.

To solve the above technical problems, the present disclosure is achieved by the following technical solutions:

In one aspect of the present disclosure, a photoelectrocatalytic reaction device for high-pressure environments is provided, including an anode reactor and a cathode reactor; wherein the anode reactor and the cathode reactor have the same structure and are arranged in a mutual mirroring manner; the anode reactor and the cathode reactor each include a reaction cavity; optics windows are arranged on opposite side walls of the two reaction cavities, and connecting channels are formed in opposite side faces thereof; the two reaction cavities are connected in butt joint through the connecting channels, and a sealing material is installed at a butt joint position; and an ion exchange membrane is arranged between the two connecting channels of the two reaction cavities;
a cover plate is arranged on a top of each reaction cavity, the cover plate is fixedly connected with the corresponding reaction cavity through a bolt, and a fluororubber sealing strip is arranged at a connection position; a gas inlet pipeline connector, a gas outlet pipeline connector and a safety valve are arranged on a side face of each cover plate; and a pressure meter is installed on a top face of the cover plate;
two I-shaped through holes are machined in each cover plate and used for installing two terminals; and each I-shaped through hole includes a lower end hole groove, an upper end hole groove and a middle hole channel, all of which are formed coaxially, the lower end hole groove and the upper end hole groove are each provided with an internal thread, and internal diameters of the lower end hole groove and the upper end hole groove are both greater than an internal diameter of the middle hole channel;
each terminal includes a nut end cover, an external threaded connection part and a bare axis part, all of which are coaxially arranged from bottom to top in sequence; the external threaded connection part is in threaded connection with the lower end hole groove of the corresponding I-shaped through hole, a connection position is sealed by a sealing ring, and meanwhile the terminal is axially limited by the nut end cover; the bare axis part penetrates through the middle hole channel and the upper end hole groove of the I-shaped through hole, and a top thereof extends out of the corresponding cover plate; and the bare axis part is externally sleeved with a male nut, the male nut is in threaded connection with the upper end hole groove of the I-shaped through hole, and a connection position is sealed by a sealing ring; and
Metal copper rods are embedded into the terminals along axes of the terminals, lower ends of the metal copper rods do not exceed the bottom of the nut end covers, and upper ends thereof extend out relative to the top of the bare axis parts; inserting holes are formed in bottoms of the metal copper rods and used for being connected with electrodes inside the reaction cavities in an inserted manner.

Furthermore, the two reaction cavities are connected together through a plurality of hexagon socket bolts, and all the hexagon socket bolts penetrate through outer shells of the two reaction cavities.

Furthermore, the reaction cavities and the cover plates are machined from metallic titanium.

Furthermore, the reaction cavities are provided with polytetrafluoroethylene liners.

Furthermore, the connecting channels have round sections.

Furthermore, the sealing material installed at the butt joint position of the two connecting channels is polytetrafluoroethylene.

Furthermore, the ion exchange membrane is one of a cation exchange membrane, an anion exchange membrane or a bipolar membrane.

Furthermore, the terminals and the male nuts are both made of polyetheretherketone.

Furthermore, the bare axis parts are in clearance fit with the middle hole channels of the I-shaped through holes.

In another aspect of the present disclosure, application of the above photoelectrocatalytic reaction device is provided, wherein the device is used for performing a carbon dioxide reduction reaction: inserting the electrodes in the reaction cavities of the anode reactor and the cathode reactor into the inserting holes of the metal copper rods; continuously introducing carbon dioxide gases into the reaction cavities of the anode reactor and the cathode reactor, so that the gas pressure in the reaction cavities goes beyond ambient pressure; performing the photoelectrocatalytic reduction reaction of carbon dioxide under continuous stirring, and reducing the carbon dioxide in the reaction cavity of the cathode reactor to obtain reduction products such as carbon monoxide and methanol; and making water to be subjected to an oxidation reaction in the reaction cavity of the anode reactor, to obtain oxygen.

The present disclosure has the following beneficial effects:

According to the photoelectrocatalytic reaction device of the present disclosure, the specially-designed terminals and the cover plates are tightly assembled without slipping at high pressure by utilizing reducing structures and double thread connections, so as to ensure photoelectrocatalytic reactions under the high-pressure environments; local stress is dispersed in combination with the round sapphire optics windows, and compression resistance of light transmitting positions is improved, thereby providing illumination conditions for high-pressure reactions; the device is compact in structure, free of complex circuit connections, capable of rapidly switching external circuits under different application scenes, and also capable of rapidly replacing types of the electrodes according to types of catalysts; and the mass transfer property in the reaction device is high, and the device is high in overall safety and good in gas tightness.

The photoelectrocatalytic reaction device of the present disclosure is provided with the anode reactor and the cathode reactor which are separated in space, so that cathode and anode reactions are generated in effectively separated electrolytes respectively, thereby effectively separating the oxidation products from the reduction products in space; due to the design of the gas inlet pipeline connectors and the gas outlet pipeline connectors, stable connection among the anode/cathode reactor, a gas cylinder and a gas chromatography is achieved, and the carbon dioxide reduction reaction can be rapidly performed conveniently, thereby facilitating quantitative analysis and detection of gas products under the high-pressure reactions.

When the photoelectrocatalytic reaction device of the present disclosure is applied to the carbon dioxide reduction reaction at high pressure, solubility of carbon dioxide in the electrolytes can be significantly increased, so that coverage of reactants on surfaces of the catalysts is also increased, the occurrence of a hydrogen evolution reaction is inhibited, conversion of carbon dioxide to carbonaceous products is promoted, and catalytic reaction efficiency is improved.

### BRIEF DESCRIPTION OF THE DRAWINGS

FIG. 1 is a schematic structural diagram of a photoelectrocatalytic reaction device provided by an embodiment of the present disclosure.

FIG. 2 is a schematic diagram of a cover plate of an anode reactor/cathode reactor provided by an embodiment of the present disclosure.

FIG. 3 is a schematic diagram of an I-shaped through hole of a cover plate of an anode reactor/cathode reactor provided by an embodiment of the present disclosure.

FIG. 4 is a schematic diagram of a terminal of an anode reactor/cathode reactor provided by an embodiment of the present disclosure.

FIG. 5 is a schematic assembly diagram of a terminal and a cover plate of an anode reactor/cathode reactor provided by an embodiment of the present disclosure.

FIG. 6 is a schematic use diagram of a photoelectrocatalytic reaction device at high pressure provided by an embodiment of the present disclosure.

FIG. 7 is a schematic use diagram of a photoelectrocatalytic reaction device at normal pressure provided by an embodiment of the present disclosure.

In the drawings: A: anode reactor; B: cathode reactor;
1: pressure meter; 2: safety valve; 3: terminal; 301: nut end cover; 302: threaded connection part; 303: bare axis part; 4: hexagon socket bolt; 5: cover plate; 6: fluororubber sealing strip; 7: optics window; 8: connecting channel; 9: ion exchange membrane; 10: reactor cavity; 11: gas outlet pipeline connector; 12: gas inlet pipeline connector; 13: threaded through hole; 14: I-shaped through hole; 1401: lower end hole groove; 1402: middle hole channel; 1403: upper end hole groove; 15: metal copper rod; 16: inserting hole; 17: sealing ring; 18: male nut; 19: gas pressure regulating valve; 20: high-pressure gas flow controller; 21: back pressure valve; 22: gas flow meter; and 23: gas chromatography.

### DETAILED DESCRIPTION OF THE PRESENT DISCLOSURE

In order to further understand the contents, features and effects of the present disclosure, the following embodiments are listed and described in detail below with reference to the drawings:

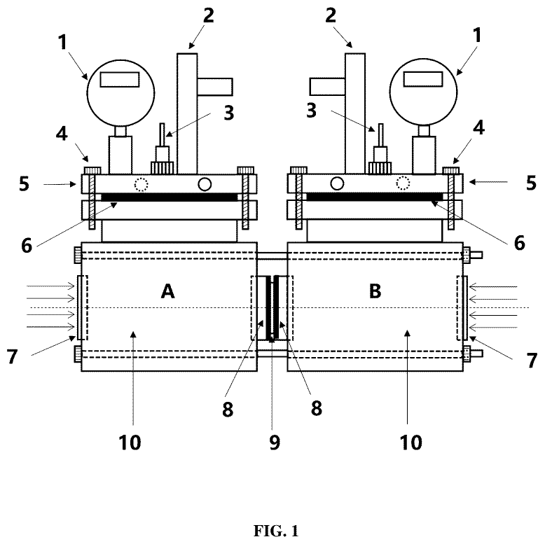

As shown in FIG. 1, the present disclosure provides a photoelectrocatalytic reaction device suitable for high-pressure environments, including an anode reactor A and a cathode reactor B, wherein the anode reactor A and the cathode reactor B have the same structure and are arranged in a mutual mirroring manner.

The anode reactor A and the cathode reactor B each include a reaction cavity 10, and the reaction cavities 10 are machined from metallic titanium. Since the metallic titanium is not magnetic, rotation of magnetic stirrers inside the reaction cavities 10 under external magnetic fields is not affected, continuous stirring of electrolytes in the closed cavities at high pressure can be achieved, convective mass transfer of carbon dioxide dissolved in the electrolytes is ensured, and the transfer rate of the carbon dioxide to the surface of a catalyst is accelerated. Liners of the reaction cavities 10 are made from polytetrafluoroethylene, so that the reaction cavities 10 are prevented from being corroded by the electrolytes, and metal impurities are prevented from being leached out, which is conducive to improving durability and catalytic reaction stability of the reaction device.

Round optics windows 7 are arranged on opposite side walls of the two reaction cavities 10, which are made of sapphire, so that not only compression resistance is improved, but also good light transmittance is ensured. Connecting channels 8 with round sections are formed in opposite side faces of the two reaction cavities 10, and the connecting channels 8 and the light windows 7 are coaxially arranged and have equal sectional areas, to achieve compression resistance and convenient machining. The two reaction cavities 10 are connected in butt joint through the connecting channels 8, and a sealing material is installed at a butt joint position. The sealing material is polytetrafluoroethylene, which prevents the electrolytes from directly making contact with metals of the reaction cavities 10, and meanwhile service life of the sealing material is prolonged due to corrosion resistance thereof, thereby reducing a possibility of liquid leakage at the butt joint position under high pressure.

An ion exchange membrane 9 is arranged between the connecting channels 8 of the two reaction cavities 10, which is selected from a cation exchange membrane, an anion exchange membrane, a bipolar membrane or the like according to properties of catalytic reactions.

The two reaction cavities 10 are connected together through a plurality of hexagon socket bolts, and each hexagon socket bolt penetrates through outer shells of the two reaction cavities 10. The hexagon socket bolts are made of 304 stainless steels.

Cover plates 5 are arranged on tops of the reaction cavities 10. The cover plates 5 are machined from metallic titanium, and the effect achieved by the metallic titanium in machining the cover plates is the same as that of the metallic titanium it does in machining the reaction cavities 10. Threaded through holes 13 are formed in upper portions of the cover plates 5 and the reaction cavities 10, which are evenly distributed in circumferential directions of the cover plates 5 and the reaction cavities 10 and used for installing hexagon socket bolts 4 for fixedly connecting the cover plates 5 and the reaction cavities 10. The hexagon socket bolts are made of the 304 stainless steels. Corrosion-resistant fluororubber sealing strips 6 are embedded into bottoms of the cover plates 5 and used for sealing connection positions of the cover plates and the reaction cavities 10.

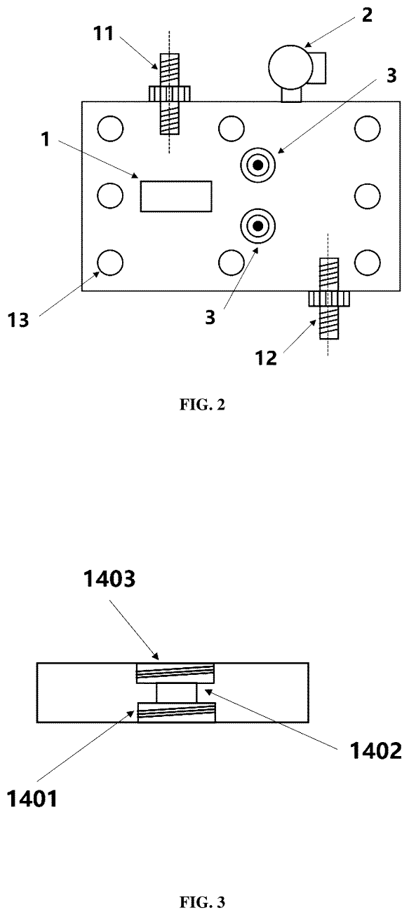

As shown in FIG. 2, gas inlet pipeline connectors 12, gas outlet pipeline connectors 11 and safety valves 2 are arranged on side faces of the cover plates 5. The gas inlet pipeline connectors 12 are connected with gas inlet pipelines to be used for introducing reactant gases. The gas outlet pipeline connectors 11 are connected with a gas chromatography 23 through gas outlet pipelines, so as to precisely quantify gas phase products. The safety of the device can be improved by the safety valves 2. Pressure meters 1 are installed on tops of the cover plates 5, which are used for precisely displaying gas pressure inside the reaction cavities 10.

As shown in FIG. 3, two I-shaped through holes 14 are machined in each cover plate 5, which are used for installing two terminals 3. Each I-shaped through hole 14 includes a lower end hole groove 1401, an upper end hole groove 1403 and a middle hole channel 1402, all of which are coaxially arranged, wherein the middle hole channel 1402 is used for making the lower end hole groove 1401 and the upper end hole groove 1403 keep communicated. Wherein, the lower end hole groove 1401 and the upper end hole groove 1403 are each provided with internal threads, the middle hole channel 1402 is smooth in an inner wall, and internal diameters of the lower end hole groove 1401 and the upper end hole groove 1403 are the same and are both greater than an internal diameter of the middle hole channel 1402.

The terminals 3 are installed on the cover plates 5, which are used for being communicated with electrodes inside the reaction cavities 10, so as to achieve photoelectrocatalytic reactions. The terminals 3 are made from polyetheretherketone, so as to ensure good insulation among the cover plates 5, the reaction cavities 10 and external circuits.

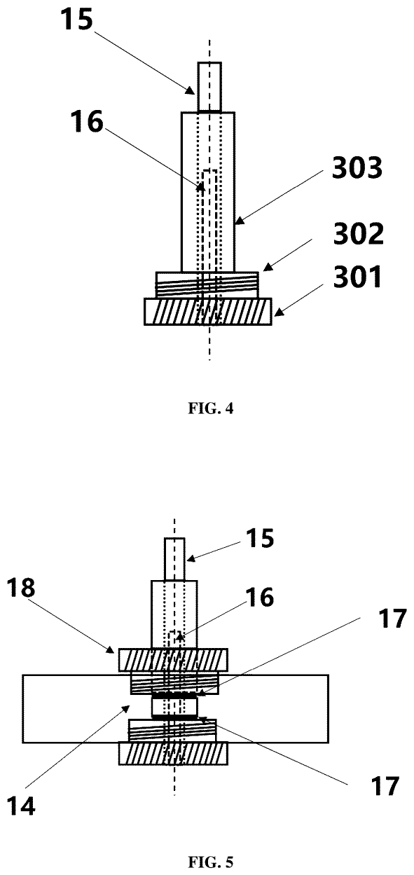

As shown in FIG. 4, the terminals 3 are integrally machined two-stage reducing cylinders. Each terminal includes a nut end cover 301, a threaded connection part 302 and an bare axis part 303, all of which are coaxially arranged from bottom to top in sequence. Wherein, the threaded connection parts 302 are provided with external threads, and the external threads are matched with the internal threads of the lower end hole channels 1401 of the I-shaped through holes 14. Wherein, surfaces of the bare axis parts 303 are smooth without threads, and external diameters thereof are in clearance fit with the internal diameters of the middle hole channels 1402 of the I-shaped through holes 14. Diameters of the bare axis parts 302 are less than those of the threaded connection parts 302, and lengths thereof are greater than those of the threaded connection parts 302. Total lengths of the threaded connection parts 302 and the bare axis parts 303 are greater than thicknesses of the cover plates 5.

Axial through holes are formed in the terminals 3 along central axes of the terminals, metal copper rods 15 are embedded into the axial through holes, and external diameters of the metal copper rods 15 are in interference fit with the axial through holes of the terminals 3, so as to ensure that no relative slipping exists between the metal copper rods 15 and the terminals 3. Lower ends of the metal copper rods 15 are flush with bottom end faces of the nut end covers 301 of the terminals 3, upper ends of the metal copper rods 15 extend out relative to top end faces of the bare axis parts 303 of the terminals 3, and extending-out parts are used for being connected with an electrochemical workstation. Inserting holes 16 are formed in bottoms of the metal copper rods 15 along central axes of the metal copper rods, and the inserting holes 16 are formed in the metal copper rods 15 as blind holes and used for being connected with electrode clamps in an inserted manner.

Thus, the terminals 3 can be connected with the electrodes inside the reaction cavities 10 and an external power supply device, which can achieve rapid replacement of the electrodes. Tight assembly without loosening is ensured due to double threaded connections of the terminals 3 and the cover plates 5, and it is ensured that the terminals do not slip relative to the cover plates 5 at high pressure due to reducing structures of the terminals 3, so that flexible connection between the electrodes inside the high-pressure cavities and the external circuits is achieved.

As shown in FIG. 5, the terminals 3 are installed in the I-shaped through holes 14 of the cover plates 5, and sealing rings 17 are installed at bottoms of the lower end hole grooves 1401 and bottoms of the upper end hole channels 1403 of the I-shaped through holes 14 respectively. By screwing the nut end covers 301 of the terminals 3, the threaded connection parts 302 of the terminals 3 are in threaded connection with the lower end hole channels 1401 of the I-shaped through holes 14, the nut end covers 301 achieve the limiting effect on the installation of the terminals 3 at the same time, and the sealing rings installed at the lower end hole channels 1401 are extruded, so as to ensure gas tightness of connection positions. Then, male nuts 18 are installed at the upper end hole channels 1403 of the I-shaped through holes 14, and external threads of the male nuts 18 are matched with the internal threads of the upper end hole channels 1403. The male nuts 18 are made from polyetheretherketone, so as to ensure good insulation among the cover plates 5, the reaction cavities 10 and the external circuits. The male nuts 18 penetrate through the optical axis parts 303 of the terminals 3 to be in threaded connection with the upper end hole channels 1403, and then the sealing rings installed at the upper end hole channels 1403 are extruded, so as to ensure gas tightness of connection positions.

The photoelectrocatalytic reaction device provided by the present disclosure is especially suitable for a carbon dioxide reduction reaction under high-pressure environments:

Firstly, the electrolytes are added to the reaction cavities 10 of the anode reactor A and the cathode reactor B respectively, and the magnetic stirrers are put therein; then a working electrode and a reference electrode are inserted into the inserting holes 16 of the terminals 3 of the cathode reactor B, a counter electrode is inserted into the inserting holes 16 of the terminals 3 of the anode reactor A, and the two cover plates 5 are fixedly connected with the reaction cavities 10 respectively; the assembled photoelectrocatalytic reaction device is put on a magnetic stirring table, followed by starting stirring; the carbon dioxide gas source is a carbon dioxide steel cylinder, which supplies gases to the anode reactor A and the cathode reactor B through a gas regulating valve 19; carbon dioxide with a controllable flow rate are introduced into the reaction cavities 10 of the anode reactor A and the cathode reactor B at the same time by utilizing high-pressure gas flow controllers 20, readings of pressure meters 1 reach set values (beyond ambient pressure) by adjusting back pressure valves 21 connected with the anode reactor A and the cathode reactor B, and the flow rate of the gases flowing out of the cathode reactor B is measured by a gas flow meter 22; and voltages of a reaction system are controlled and currents in a circuit of the reaction system are measured by the electrochemical workstation under the condition of continuously introducing the gases, and the photoelectrocatalytic reduction reaction of carbon dioxide starts under continuous stirring. The carbon dioxide is reduced in the cathode reactor B, to obtain reduction products such as carbon monoxide and methanol, and water is subjected to an oxidation reaction in the anode reactor A, to generate oxygen.

### Embodiment 1

A reference electrode in a three-electrode reaction system is an Ag/AgCl reference electrode; a counter electrode is an anode, which is a graphite electrode; and a working electrode is a cathode, which is a glassy carbon electrode loaded with a carbon dioxide reduction catalyst. An ion exchange membrane 9 is a bipolar membrane (Fumasep, FBM-PK-130).

During the use of the photoelectrocatalytic reaction device provided by the present disclosure, 15 ml of a 0.1 M KHCO₃ aqueous solution is added into reaction cavities 10 of an anode reactor A and a cathode reactor B respectively. The glassy carbon electrode loaded with the carbon dioxide reduction catalyst, as the working electrode, is connected with one terminal 3 of the cathode reactor B, the Ag/AgCl reference electrode is connected with the other terminal 3 of the cathode reactor B, the graphite electrode, as the counter electrode, is connected with the terminals 3 of the anode reactor A, and cover plates 5 in which each electrode is inserted are put on upper portions of the reaction cavities 10 of the anode reactor A and the cathode reactor B respectively, a magnetic stirrer is put into each of the reaction cavities 10 of the anode reactor A and the cathode reactor B, and the cover plates 5 and the reaction cavities 10 are sealed and connected by hexagon socket bolts 4.

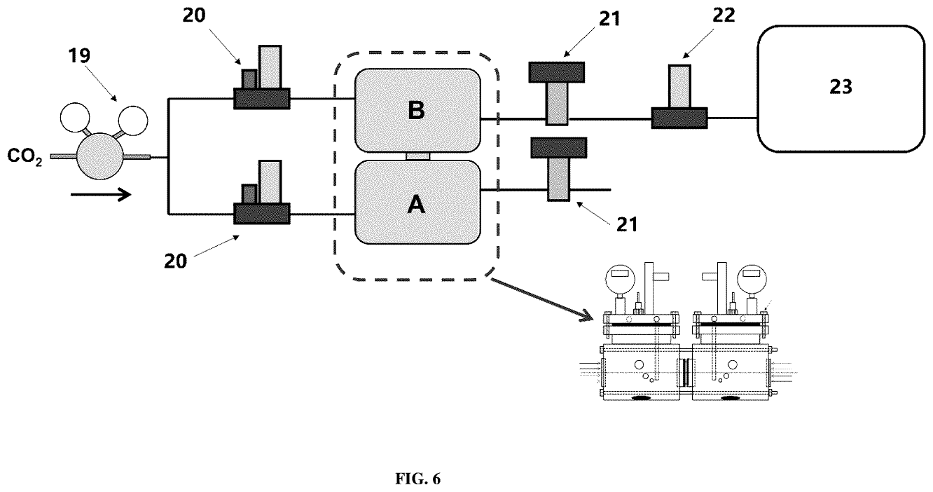

With reference to FIG. 6, carbon dioxide gas pipelines are connected with gas inlet connectors 12, back pressure valves 21 are connected with gas outlet connectors 11 in the cover plates 5, carbon dioxide gases are continuously introduced into the reaction cavities 10 of the anode reactor A and the cathode reactor B by high-pressure gas flow controllers 20, opening degrees of the back pressure valves 21 are adjusted till pressure meters 1 of the anode reactor A and the cathode reactor B reach 6 MPa, the photoelectrocatalytic reaction device is put on the magnetic stirrer, followed by starting stirring, the terminals 3 of the anode reactor A and the cathode reactor B are connected with an electrochemical workstation, and bias voltages of −0.8984 V are applied to the working electrode vs. the Ag/AgCl electrode before the start of a reaction.

The headspace gas of the cathode reactor B is quantified by a gas chromatography 23 during the reaction. The device is completely subjected to pressure relief after the reaction, and the electrolyte of the cathode reactor B is taken out for analysis of concentrations of liquid phase products. After three hours of the reaction, yields of reduction products generated in the photoelectrocatalytic reaction device can be detected, as shown in Table 1:

TABLE 1

| | Yield | | |
|---|---|---|---|
| Time | Hydrogen | Carbon monoxide | Methanol |
| 3 h | 10.4 μM | 20.5 μM | 63.4 μM |

It can be shown from Table 1 that by means of the photoelectrocatalytic reaction device, concentrations of the carbon dioxide gases dissolved in the electrolytes under the reaction condition can be significantly improved, so as to inhibit generation of a hydrogen evolution side reaction, promote generation of carbonaceous reduction products, and improve efficiency of the electrocatalytic reduction reaction of carbon dioxide.

### Embodiment 2

A reference electrode in a three-electrode reaction system is an Ag/AgCl reference electrode; a counter electrode is an anode, which is a graphite electrode; and a working electrode is a cathode, which is a glassy carbon electrode loaded with a carbon dioxide reduction catalyst. An ion exchange membrane 9 is a bipolar membrane (Fumasep, FBM-PK-130).

During the use of the photoelectrocatalytic reaction device provided by the present disclosure, 15 ml of a 0.1 M KHCO₃ aqueous solution is added into reaction cavities 10 of an anode reactor A and a cathode reactor B respectively. The glassy carbon electrode loaded with the carbon dioxide reduction catalyst, as the working electrode, is connected with one terminal 3 of the cathode reactor B, the Ag/AgCl reference electrode is connected with the other terminal 3 of the cathode reactor B, the graphite electrode, as the counter electrode, is connected with the terminals 3 of the anode reactor A, and cover plates 5 in which each electrode is inserted are put on upper portions of the reaction cavities 10 of the anode reactor A and the cathode reactor B respectively, a magnetic stirrer is put into each of the reaction cavities 10 of the anode reactor A and the cathode reactor B, and the cover plates 5 and the reaction cavities 10 are sealed and connected by hexagon socket bolts 4.

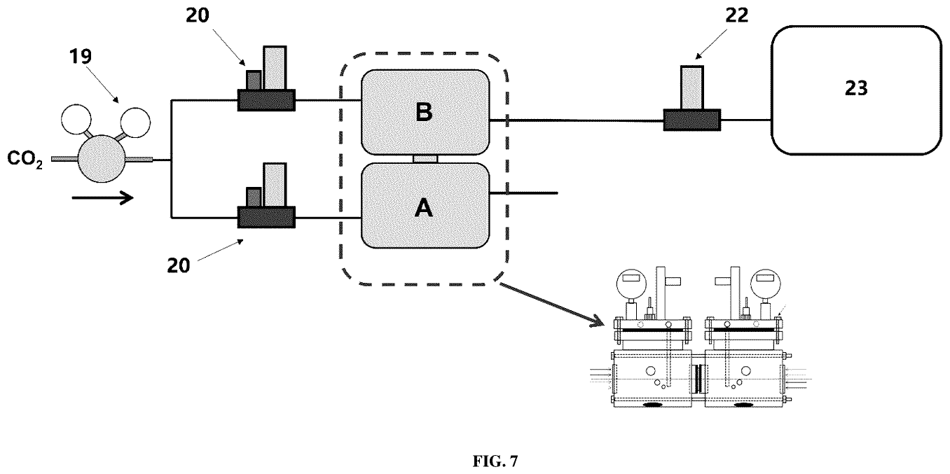

With reference to FIG. 7, carbon dioxide gas pipelines are connected with gas inlet connectors 12, carbon dioxide gases are continuously introduced into the reaction cavities 10 of the anode reactor A and the cathode reactor B by high-pressure gas flow controllers 20, the photoelectrocatalytic reaction device is put on the magnetic stirrer, followed by starting stirring, the terminals 3 of the anode reactor A and the cathode reactor B are connected with an electrochemical workstation, and bias voltages of −0.8984 V are applied to the working electrode vs. the Ag/AgCl electrode before the start of a reaction.

A headspace gas phase of the cathode reactor B is quantified by a gas chromatography 23 during the reaction. After the reaction, the electrolyte of the cathode reactor B is taken out for analysis of concentrations of liquid phase products. After three hours of the reaction, yields of reduction products generated in the photoelectrocatalytic reaction device can be detected, as shown in Table 2:

TABLE 2

| | Yield | | |
|---|---|---|---|
| Time | Hydrogen | Carbon monoxide | Methanol |
| 3 h | 70.8 μM | 10.6 μM | 8.8 μM |

It can be shown from Table 2 that when reaction pressure is ambient pressure, concentrations of the carbon dioxide in the electrolytes are low, and the carbon dioxide reduction reaction hardly competes with a hydrogen evolution reaction, so that generation of carbonaceous reduction products is inhibited.

### Embodiment 3

A reference electrode in a three-electrode reaction system is an Ag/AgCl reference electrode; a counter electrode is a cathode, which is a glassy carbon electrode loaded with a carbon dioxide reduction catalyst; and a working electrode is an anode, which is a titanium dioxide nanorod growing on conductive glass. An ion exchange membrane 9 is a bipolar membrane (Fumasep, FBM-PK-130).

During the use of the photoelectrocatalytic reaction device provided by the present disclosure, 15 ml of a 0.1 M KHCO₃ aqueous solution is added into reaction cavities 10 of an anode reactor A and a cathode reactor B respectively. The glassy carbon electrode loaded with the carbon dioxide reduction catalyst, as the counter electrode, is connected with one terminal 3 of the cathode reactor B, the Ag/AgCl reference electrode is connected with one terminal 3 of the anode reactor A, the titanium dioxide nanorod growing on conductive glass, as the working electrode, is connected with the other terminal 3 of the anode reactor A, cover plates 5 in which each electrode is inserted are put on upper portions of the reaction cavities 10 of the anode reactor A and the cathode reactor B respectively, a magnetic stirrer is put into each of the reaction cavities 10 of the anode reactor A and the cathode reactor B, and the cover plates 5 and the reaction cavities 10 are sealed and connected by hexagon socket bolts 4.

With reference to FIG. 6, carbon dioxide gas pipelines are connected with gas inlet connectors 12, back pressure valves 21 are connected with gas outlet connectors 11 in the cover plates 5, carbon dioxide gases are continuously introduced into the reaction cavities 10 of the anode reactor A and the cathode reactor B by high-pressure gas flow controllers 20, opening degrees of the back pressure valves 21 are adjusted till pressure meters 1 of the anode reactor A and the cathode reactor B reach 6 MPa, the photoelectrocatalytic reaction device is put on the magnetic stirrer, followed by starting stirring, the terminals 3 of the anode reactor A and the cathode reactor B are connected with an electrochemical workstation, and bias voltages of +0.14 V are applied to the working electrode vs. the Ag/AgCl electrode before the start of a reaction.

A headspace gas phase of the cathode reactor B is quantified by a gas chromatography 23 during the reaction. After the reaction, the electrolyte of the cathode reactor B is taken out for analysis of concentrations of liquid phase products. After three hours of the reaction, yields of reduction products generated in the photoelectrocatalytic reaction device can be detected, as shown in Table 3:

TABLE 3

| | Yield | | |
|---|---|---|---|
| Time | Hydrogen | Carbon monoxide | Methanol |
| 3 h | 1.2 μM | 1.5 μM | 0.36 μM |

It can be shown from Table 3 that by means of the photoelectrocatalytic reaction device designed by the present disclosure, good light transmittance and tightness can be ensured, photoelectric conversion efficiency of photoelectrodes is ensured while increasing reaction pressure, generation of a hydrogen evolution reaction is inhibited, generation of carbonaceous reduction products is promoted, and selectivity of the photoelectrocatalytic reduction reaction of carbon dioxide is improved.

Although the preferred embodiments of the present disclosure are described with reference to the drawings above, the present disclosure is not limited to the above specific implementations, and the above specific implementations are only schematic instead of restrictive. Those ordinarily skilled in the art may also make many forms of specific transformations without departing from the purpose of the present disclosure and the scope protected by the claims under inspiration of the present disclosure, and these transformations all belong to the protection scope of the present disclosure.

1. A photoelectrocatalytic reaction device for high-pressure environments, comprising an anode reactor and a cathode reactor; wherein the anode reactor and the cathode reactor have the same structure and are arranged in a mutual mirroring manner; the anode reactor and the cathode reactor each include a reaction cavity; round optics windows are arranged on opposite side walls of the two reaction cavities, and connecting channels are formed in opposite side faces thereof; and the two connecting channels are connected in butt joint, a sealing material is installed at a butt joint position, and an ion exchange membrane is arranged between the two connecting channels;
a cover plate is arranged on a top of each reaction cavity, the cover plate is fixedly connected with the corresponding reaction cavity through a bolt, and a fluororubber sealing strip is arranged at a connection position; a gas inlet pipeline connector, a gas outlet pipeline connector and a safety valve are arranged on a side face of each cover plate; and a pressure meter is installed on the top face of the cover plate;
two I-shaped through holes are machined in each cover plate and used for installing two terminals; and each I-shaped through hole comprises a lower end hole groove, an upper end hole groove and a middle hole channel, all of which are formed coaxially, the lower end hole groove and the upper end hole groove are each provided with an internal thread, and internal diameters of the lower end hole groove and the upper end hole groove are both greater than an internal diameter of the middle hole channel;
each terminal comprises a nut end cover, a threaded connection part and an bare axis part, all of which are coaxially arranged from bottom to top in sequence; the threaded connection part is in threaded connection with the lower end hole groove of the corresponding I-shaped through hole, a connection position is sealed by a sealing ring, and meanwhile the terminal is axially limited by the nut end cover; the bare axis part penetrates through the middle hole channel and the upper end hole groove of the I-shaped through hole, and a top thereof extends out of the corresponding cover plate; and the bare axis part is externally sleeved with a male nut, the male nut is in threaded connection with the upper end hole groove of the I-shaped through hole, and a connection position is sealed by a sealing ring; and
metal copper rods are embedded into the terminals along axes of the terminals, lower ends of the metal copper rods do not exceed bottom faces of the nut end covers, and upper ends thereof extend out relative to top faces of the bare axis parts; and inserting holes are formed in bottoms of the metal copper rods and used for being connected with electrodes inside the reaction cavities in an inserted manner.

2. The photoelectrocatalytic reaction device for the high-pressure environments according to claim 1, wherein the two reaction cavities are connected together through a plurality of hexagon socket bolts, and all the hexagon socket bolts penetrate through outer shells of the two reaction cavities.

3. The photoelectrocatalytic reaction device for the high-pressure environments according to claim 1, wherein the reaction cavities and the cover plates are machined from metallic titanium.

4. The photoelectrocatalytic reaction device for the high-pressure environments according to claim 1, wherein the reaction cavities are provided with polytetrafluoroethylene liners.

5. The photoelectrocatalytic reaction device for the high-pressure environments according to claim 1, wherein the connecting channels have round sections.

6. The photoelectrocatalytic reaction device for the high-pressure environments according to claim 1, wherein the sealing material installed at the butt joint position of the two connecting channels is polytetrafluoroethylene.

7. The photoelectrocatalytic reaction device or the high-pressure environments according to claim 1, wherein the ion exchange membrane is one of a cation exchange membrane, an anion exchange membrane or a bipolar membrane.

8. The photoelectrocatalytic reaction device for the high-pressure environments according to claim 1, wherein the terminals and the male nuts are both made from polyetheretherketone.

9. The photoelectrocatalytic reaction device for the high-pressure environments according to claim 1, wherein the bare axis parts are in clearance fit with the middle hole channels of the I-shaped through holes.

10. Application of the photoelectrocatalytic reaction device according to claim 1, wherein the device is used for performing a carbon dioxide reduction reaction: inserting the electrodes inside the reaction cavities of the anode reactor and the cathode reactor into the inserting holes of the metal copper rods; continuously introducing carbon dioxide gases into the reaction cavities of the anode reactor and the cathode reactor, so that pressure of the gases in the reaction cavities goes beyond ambient pressure; performing the photoelectrocatalytic reduction reaction of carbon dioxide under continuous stirring, and reducing the carbon dioxide in the reaction cavity of the cathode reactor, to obtain reduction products such as carbon monoxide and methanol; and making water to be subjected to an oxidation reaction in the reaction cavity of the anode reactor, to obtain oxygen.

11. The application of the photoelectrocatalytic reaction device of claim 10, wherein the two reaction cavities are connected together through a plurality of hexagon socket bolts, and all the hexagon socket bolts penetrate through outer shells of the two reaction cavities.

12. The application of the photoelectrocatalytic reaction device of claim 10, wherein the reaction cavities and the cover plates are machined from metallic titanium.

13. The application of the photoelectrocatalytic reaction device of claim 10, wherein the reaction cavities are provided with polytetrafluoroethylene liners.

14. The application of the photoelectrocatalytic reaction device of claim 10, wherein the connecting channels have round sections.

15. The application of the photoelectrocatalytic reaction device of claim 10, wherein the sealing material installed at the butt joint position of the two connecting channels is polytetrafluoroethylene.

16. The application of the photoelectrocatalytic reaction device of claim 10, wherein the ion exchange membrane is one of a cation exchange membrane, an anion exchange membrane or a bipolar membrane.

17. The application of the photoelectrocatalytic reaction device of claim 10, wherein the terminals and the male nuts are both made from polyetheretherketone.

18. The application of the photoelectrocatalytic reaction device of claim 10, wherein the bare axis parts are in clearance fit with the middle hole channels of the I-shaped through holes.
